(19) United States
(12) Patent Application Publication
(10) Pub. No.: US 2012/0109752 A1
(43) Pub. Date: May 3, 2012

(54) SYSTEMS AND METHODS FOR DELIVERING TARGETED CONTENT TO A CONSUMER'S MOBILE DEVICE BASED ON THE CONSUMER'S PHYSICAL LOCATION AND SOCIAL MEDIA MEMBERSHIPS

(75) Inventors: Michael J. Strutton, Villa Rica, GA (US); John B. Nolt, Atlanta, GA (US); Sean Sawyer, Atlanta, GA (US); John Schult, Buford, GA (US); Jon M. Lee, Atlanta, GA (US); Kurt B. Uhlir, Atlanta, GA (US); Jason C. Reynolds, Covington, GA (US)

(73) Assignee: VITRUE, INC., Atlanta, GA (US)

(21) Appl. No.: 13/267,772

(22) Filed: Oct. 6, 2011

Related U.S. Application Data
(63) Continuation-in-part of application No. 12/859,675, filed on Aug. 19, 2010.
(60) Provisional application No. 61/235,277, filed on Aug. 19, 2009.
(60) Provisional application No. 61/390,565, filed on Oct. 6, 2010.

(51) Int. Cl. G06Q 30/02

(52) U.S. Cl. 705/14.58

(57) ABSTRACT

Systems and methods for creation, management and delivery of targeted marketing campaigns to a consumer based on a consumer's social check-in activity as identified by a consumer on one or more location based social networks. In one embodiment, a campaign management system receives information relating to a consumer's social check-in activity from various (heterogeneous) location based social networks in a wide variety of formats, and further normalizes such disparate information received into a standardized format. According to an aspect, the system processes the normalized information in conjunction with pre-stored marketing campaigns created by marketers for purposes of identifying consumers who satisfy one or more conditions specific to the pre-stored marketing campaigns. Campaign-related information corresponding to the pre-stored marketing campaigns generally comprise various promotional offers, discounts, coupons, etc., which are delivered to the identified consumers, who initiate some kind of action thereby fulfilling the marketing campaign.

### CROSS-REFERENCE TO RELATED APPLICATIONS

This application is a continuation-in-part application, and claims the benefit of and priority under 35 U.S.C. §120 to U.S. patent application Ser. No. 12/859,675 filed Aug. 19, 2010, and entitled “Systems and Methods for Managing Marketing Programs on Multiple Social Media Systems”, which in turn claimed the benefit of and priority under 35 U.S.C. §119(e) to U.S. Provisional Patent Application No. 61/235,277 filed Aug. 19, 2009, and entitled “Social Relationship Manager System and Method.” In addition, the present application also claims benefit under 35 U.S.C. §119(e) of U.S. Provisional Patent Application No. 61/390,565, filed Oct. 6, 2010, and entitled “Systems and Methods For Delivering Targeted Marketing Offers to a Consumer's Mobile Device Based on the Consumer's Physical Location and Social Media Memberships”. All of the above-referenced applications are hereby incorporated by reference as if set forth herein in their entireties.

### TECHNICAL FIELD

The present disclosure relates generally to computer-based targeted content delivery systems, and more particularly to systems and methods for aggregation and manipulation of information with respect to a consumer's social activities at various times and geo-locations, such information typically being provided by various social networks.

### BACKGROUND

Location-based social networks (LBSNs) are becoming increasingly popular among persons as a way to disseminate information relating to a consumer's geographical location in a real time manner with the outside world. Generally, LBSNs are social networks that enable their members (users) to share information with others (e.g., other LBSN members) relating to the members' physical locations or attendance at temporal events. Often, this location or temporal information is provided by members of LBSNs to the LBSNs via the members' electronic mobile devices (e.g., cellular phones, smartphones, PDAs, etc.). Generally, information broadcast by LBSNs provides an indication to other members of the LBSN regarding the member's social activities in a spatial and/or a temporal sense. Typically, members provide this information to an LBSN through a “check-in,” which is essentially a way of providing to a LBSN information indicating a member's social activities or geographical locations. For example, when a person is at a venue such as a restaurant, then the person (or, a person's electronic mobile device) performs a spatial check-in at the restaurant. In another example, a person can inform a LBSN via a temporal check-in such as a football game that the person will attend on a specific future date.

Additionally, persons who are members of a LBSN can also provide (as part of the check-in information) reviews, ratings or more generally, any experiences in connection with a venue. The LBSN broadcasts information indicating the respective person's current venue (or related information such as the person's experience therein) to other persons who are also members of the same LBSN. In many cases, a LBSN can publish the check-in activity or other activities of a person on various social media systems, thus allowing friends and connections of the persons to become aware of the person's social activity in connection with a venue and/or a time.

In many scenarios, LBSNs are also used by persons to identify and locate nearby banks, restaurants, gas stations, hospitals or other points of interest. Typically LBSNs are accessible via a person's mobile device such as a smart phone, tablet PC, or any other computing device that is able to communicate a person's physical location, and/or a time, automatically to the LBSNs through one or more mobile networks. Examples of LBSNs include LOOPT™, FOURSQUARE™, BRIGHKITE™, FACEBOOK™ PLACES™, GOOGLE™ LATITUDE™, and GOWALLA™ to name just a few. Generally, LBSNs enable persons to share information relating to their locations with the help of mobile device application programs that are easily downloadable by consumers onto their mobile devices, and subsequently installed for use by persons. In some scenarios, LBSNs are also accessible via a browser program installed on the person's mobile phone device.

In many scenarios, LBSNs often provide a platform to deliver to consumers targeted content (including targeted marketing offers) from companies or owners of retail establishments, generally referred to herein as marketers. Members of LBSNs who typically are consumers of various goods and services offered by one or more marketers, receive information (such as, advertisements and messages) relating to the marketers, either from LBSNs, or from the marketers directly. In general, marketers maintain business relationships with LBSNs in order to encourage consumers to purchase goods and services from the marketers. In other words, LBSNs help boost sales for marketers by driving consumers to brick-and-mortar stores. When a consumer who is a member of a respective LBSN checks-in at a location, or even in some cases, in the vicinity of the location corresponding to the participating marketers, then the marketer delivers advertisement content, various coupons, promotional offers etc. to the consumer. For example, some LBSN-provided mobile device application programs allow consumers to use the GPS function on their phones to search for nearby businesses, and makes it possible for advertisements from participating retailers to appear in the search results. The advertisements typically contain various types of information, such as a web link to a retailer's website, directions to the store, various promotional offers, discount coupons, etc.

In some scenarios, consumers are rewarded with virtual items such as “badges”, loyalty points, or reward certificates depending on the time, venue and frequencies of consumers' check-ins at the locations corresponding to the participating marketers. Such virtual items can be redeemed for several consumer incentives, such as discounts, promotions, cash-backs, and various offers from participating marketers. Specific criteria that govern reward of such virtual items to consumers are typically decided by the participating marketers, and implemented by the LBSNs.

In alternative scenarios, some marketers provide discounts to consumers who check-in at the same time as a group, or to high-volume, repeat consumers. Other LBSNs allow marketers to conduct polls, surveys, interactive online games (such as scavenger hunts etc.), or deliver coupons to consumers via email or SMS text alerts. In other scenarios, some LBSNs provide consumer analytics to marketers that help marketers in market segmentation on the basis of consumer demographics. Thus, broadly speaking, in comparison to traditional channels for delivering advertisements to consumers, LBSNs provide marketers the ability to target consumers directly at a specific geographical place and in real time.

Despite the above-mentioned benefits provided by LBSNs, the process of creating targeted and delivering targeted marketing content can be quite complicated and even cumbersome, depending on the LBSN and the targeted content. Moreover, a diverse variety of LBSNs each differing in their operational aspects and characteristics, creates an overwhelming multitude of options for marketers. For example, in order to deliver targeted content to consumers across a host of LBSNs, marketers must interface with each individual LBSN to track consumers, and subsequently send them content. To complicate matters, LBSNs operate in silos and have users (consumers) with disparate demographic characteristics, and further differ on rules, policies and standards of the marketing tools that they provide for marketers. For example, one LBSN might provide individual consumer and group-based loyalty points, but may not provide scavenger hunts and online social games. Yet, another LBSN might provide a completely different set of features.

As a consequence, there is a long-felt but unresolved need to develop a consolidated approach in developing systems and methods that allow for integration of multiple LBSNs with a diverse set of marketing tools and information formats under a single consolidated framework for creation and management of marketing campaigns. Such a framework would allow marketers to create targeted marketing offers for delivery to consumers registered across multiple LBSNs, wherein consumer activity is monitored across multiple LBSNs. An ideal system should be easily customizable by marketers, wherein the marketing campaigns can be created easily by individuals with minimal technical skills. Further, such a system should allow marketers to evaluate the impact of a marketing campaign by providing various meaningful qualitative and quantitative analytics relating to market segmentation. Even further, consumers should be able to choose their preferred ways of delivery of the targeted marketing campaigns (e.g., via SMS, email, etc.).

### BRIEF SUMMARY

Briefly described, and according to one embodiment, aspects of the present disclosure generally relate to systems and methods related to management of marketing campaigns involving delivery of targeted marketing offers to consumers based on aggregating information with respect to a consumer's physical location. Information relating to a consumer's physical location is usually received from one or more LBSNs. Generally, consumers who are members of one or more LBSNs typically utilize LBSNs to inform and share with other persons the consumer's social activity experiences in connection with various locations the consumer visits at different times, and for different reasons. For example, a consumer can check-in at a bar, at a football game, a concert, or the like. Such information can be utilized to offer targeted marketing campaigns to consumers based on their social activity preferences and their geo-locations. Thus, in an exemplary scenario, a consumer who frequents a particular bar and checks in every time might received discounted drinks. In one exemplary aspect, information relating to a consumer's geo-location is usually obtained with the help of a location sensor embedded in a consumer's mobile device, and automatically communicated over an electronic network to the LBSN.

According to one aspect and described in greater detail herein, a Campaign Management System (CMS) requests and receives information relating to a consumer's social activity from one or more LBSNs. However, it will be understood that LBSNs differ in their operational characteristics, including the format as well as the type of information they provide to the CMS and relating to a consumer's social activity. Hence, the present disclosure relates to integrating aspects of various location-based social networks (LBSNs) in one unified framework by normalizing information received and sent to such networks.

Furthermore, in another aspect, marketers can create and manage marketing campaigns that will be delivered by the CMS to consumers via SMS, email, or some other delivery mechanism. Marketers can choose to deliver various messages, polls, promotional offers, coupons, loyalty points, etc. In an exemplary aspect, the CMS delivers targeted marketing campaigns based on a consumer's geo-location, or in the vicinity of a geo-location.

According to one aspect, the CMS also performs the task of administering and monitoring marketing campaigns for various marketers. As will be understood from the discussions that follow, aspects of the present disclosure involved in delivery of targeted marketing campaigns include various computer processing steps comprising data mining and manipulations. For instance, marketers can access the CMS via a user-friendly interface and review pre-created marketing campaigns, obtain various types of analytics relating to a consumer's activity (including geo-locations), specify target geo-locations or vicinities of target geo-locations wherein consumers will receive marketing campaigns, and the like. According to another aspect, the CMS leverages functionalities of one or more LBSNs, relieving consumers of the need to sign up with multiple LBSNs, and hence consumers do not need to develop marketing content, protocols, messaging systems, and the like for a host of various LBSNs. Even further, in yet another aspect, the CMS provides a registration interface that allows consumers to sign up to receive targeted content from the CMS (and developed by marketers).

### BRIEF DESCRIPTION OF THE DRAWINGS

The accompanying drawings illustrate one or more embodiments of the disclosure and, together with the written description, serve to explain the principles of the disclosure. Wherever possible, the same reference numbers are used throughout the drawings to refer to the same or like elements of an embodiment, and wherein:

FIG. 1 illustrates an overview of an embodiment of a Campaign Management System (CMS) for creating and managing targeted marketing content aimed at consumers who are members of different LBSNs.

FIG. 2 shows an exemplary CMS architecture comprising various software modules, engines and other similar elements, according to one embodiment of the present system.

FIG. 3A is an exemplary sequence diagram illustrating steps comprising interactions involving an embodiment of the CMS and various other associated components operating in an exemplary environment.

FIG. 3B is an exemplary sequence diagram illustrating steps comprising interactions involving an alternate embodiment of the CMS and various other associated components, wherein the CMS leverages functionalities of LBSNs operating in an exemplary environment.

FIG. 4 is a flowchart showing computer-implemented method steps included in an exemplary CMS process for creating and managing targeted marketing offers based on consumer activity information from LBSNs and marketers, according to one embodiment of the present system.

FIG. 5 shows an exemplary check-in data table storing several variables related to a consumer's social check-in activity, used in connection with one embodiment of the present system.

FIG. 6 shows an exemplary LBSN data table storing several attributes related to various LBSNs and the information they provide, used in connection with one embodiment of the present system.

FIG. 7 shows an exemplary consumer data table storing a history of consumers' past check-in activities, used in connection with one embodiment of the present system.

FIG. 8 shows an exemplary screenshot of an interface for a consumer to register with the CMS for purposes of receiving targeted marketing content from marketers via the CMS, used in connection with one embodiment of the present system.

FIG. 9 shows an exemplary screenshot of an interface for creation of a marketing campaign as used by marketers, used in connection with one embodiment of the present system.

FIG. 10 shows an exemplary screenshot (as seen by marketers) of an interface displaying geo-targets specified by marketers and used by the CMS as campaign-specific matching criteria for purposes of delivery of marketing campaigns to consumers, used in connection with one embodiment of the present system.

FIG. 11 shows an exemplary screenshot (as seen by marketers) of an interface displaying information relating to consumer check-ins at various locations, used in connection with one embodiment of the present system.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

Aspects of the present disclosure generally relate to systems and methods for delivering targeted content to consumers across a plurality of discrete, location-based social networks (LBSNs). Generally, LBSNs are social networks that enable their members (users) to share information with others (e.g., other LBSN members) relating to the members' physical locations or attendance at temporal events. Typically, information relating to consumers' social activities is collected by one or more LBSNs, and further broadcast to other members of the LBSN or consumer's social networks. In one exemplary aspect, information relating to a consumer's social activities includes a consumer's geo-location in real time corresponding to a location where the consumer checked-in with one or more LBSNs. In one example, if a consumer's geo-location check-in corresponds to one or more physical locations pre-specified by marketers in marketing campaigns, then a consumer receives targeted marketing content from marketers. In one aspect, consumers check-in using their mobile device such as mobile phones, tablet PCs, etc., and thus receive targeted content from marketers on the respective mobile device. Aspects of the present disclosure are also related to creating and managing targeted marketing content, and further the delivery of such content to consumers based on satisfaction of criteria provided by marketers in their targeted marketing content with information related to consumer check-ins.

Typically, a location sensor embedded in a consumer's mobile device obtains a consumer's geo-location in real time and automatically communicates such information over an electronic network to one or more LBSNs. Such information is then provided by LBSNs to a Campaign Management System (CMS) that aggregates, manipulates, and normalizes the diverse types of information relating to consumers' social activities, such information being used to deliver targeted marketing content to consumers from marketers (e.g., corporations, companies, owners of retail establishments, etc.). Because LBSNs often differ in their operating rules, policies and standards, it will be understood and appreciated that such manipulation by the CMS allows marketers to acquire and further process in one integrated platform information relating to consumers' social activities as obtained from a plurality of LBSNs.

According to one aspect, the CMS provides to marketers an interactive, user-friendly graphical user interface (GUI) accessible via the World Wide Web (WWW) for creation and management of targeted marketing content. In one aspect, the CMS allows marketers to create their marketing campaigns, usually to reach out to new consumers, based on general consumer activity obtained from a plurality of LBSNs. In another aspect, marketers can create marketing campaigns by leveraging their existing consumer bases. In such scenarios, the CMS tracks the activities of individual consumers in that consumer base when those consumers check-in at various venues or at different times. As a consequence of such tracking, the disclosed CMS has the ability to extract several useful analytics associated with consumers when they visit multiple venues, at different times, and for different reasons. For example, a consumer can check-in at a bar, at a football game, a concert, or the like. Generally speaking, “check-ins” are consumer activities recorded by consumers with their respective LBSNs with respect to specific times and/or specific geographic locations. In one aspect, consumers can post messages relating to a future social activity (for example, a party, a camping trip, a concert event, etc.) on the consumer's social media system profile page. As referred to herein, and for purposes of this disclosure, it will be understood that an LBSN is a social network that includes the ability to identify and process location-based or temporal-based activities of its members, and receive and share information from its members relating to such activities.

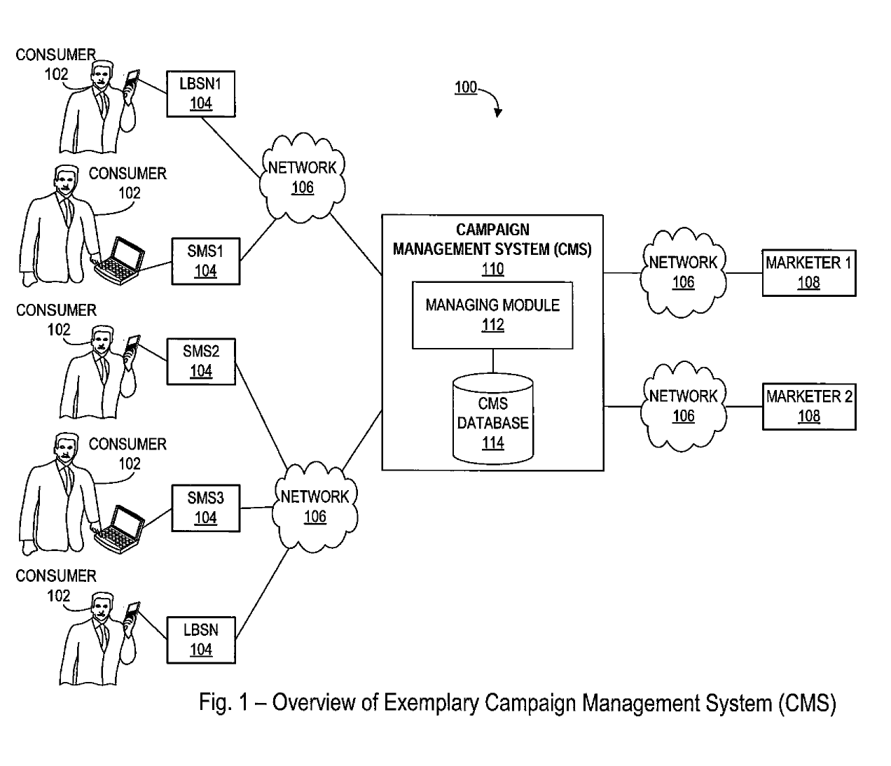

Referring now to the figures, FIG. 1 illustrates an overview 100 of an embodiment of a campaign management system (CMS) 110 in an exemplary environment, constructed and operated in accordance with various aspects of the present disclosure. According to one embodiment of the present disclosure, the CMS 110 allows marketers 108 to acquire and further process acquires information relating to consumers' social activities (alternately referred to herein as a check-in), such information typically being obtained from a plurality of LBSNs 104. Marketers 108 maintain business relationships with the entity that hosts the CMS 110, whereas such an entity in turn, maintains business relationships with a plurality of LBSNs 104.

When a consumer 102 who is a member of a respective LBSN 104 checks-in (using a mobile device) at a location, or even in some cases, in the vicinity of the location corresponding to a participating marketer, information relating to the consumer's check-in is communicated first from the consumer's mobile device to the LBSN 104, which is then relayed again by the LBSN 104 to the CMS 110. In one exemplary scenario, such locations generally correspond to physical locations that, if a consumer checks-in at such locations, the consumer will receive targeted marketing content on the consumer's mobile device.

Generally speaking, consumer check-ins with one or more LBSN 104 corresponding to a temporal or spatial event. An example of a temporal event might be a house party, wedding, concert, or a football game which are generally predetermined events scheduled for a specific date and time. On the other hand, a spatial event generally corresponds to a physical location that is not generally predetermined in time. For example, if a consumer checks in at a restaurant or a coffee shop, then such an event might be considered a spatial event. As will be understood and appreciated, many events have both spatial and temporal features, and check-ins for these types of events may include information relating to one or both. Although not shown herein, it will be understood that prior to temporal or spatial check-ins, consumers generally must register with a respective LBSN in order to become a member of the respective LBSN.

In one embodiment of the present system, it will be understood that a check-in by a consumer 102 at a geo-location involves a real-time communication of the consumer's current location to a respective LBSN 104. Generally, the CMS requests such information from one or more LBSNs, which thereafter provides the check-in information to the CMS. According to one aspect of the present disclosure, information corresponding to a consumer's current location is transmitted (to LBSNs or the CMS) by a mobile device application program running on the consumer's mobile device, wherein the instantaneous location is obtained with the help of a location sensor embedded in the mobile device that communicates with the mobile device application program running on the consumer's mobile device. Alternately, a mobile device application program running on the consumer's mobile device communicates with a third-party location-based service provider (such as LOCAID™, of San Francisco, Calif., for example) which then provides the consumer's current location to a LBSN 104. It will be understood that the mobile device application program can be provided by the CMS 110, LBSNs 104, or marketers 108.

According to another aspect, the location sensor can use software to determine its current location by using network information, such as Internet addresses or WIFI network addresses. According to yet another aspect, the real-time location of a consumer's mobile device can be retrieved by using mobile cell tower information, cell tower triangulation information, or mobile network information. Examples of consumer's mobile devices include, but are not limited to, mobile phones, cellular phones, “smart” phones, personal digital assistants (PDAs), tablet computing devices or any other electronic device that is capable of accessing the world wide web. As will be understood and appreciated by one of ordinary skill in the art, various mechanisms can be utilized to identify a current geographic location of a consumer's mobile device according to various aspects of the present system, and embodiments of the present system are not limited to the specific mechanisms described herein. Further, a consumer's mobile device can include various other devices and systems that are already known in the art, and that will be introduced in the future.

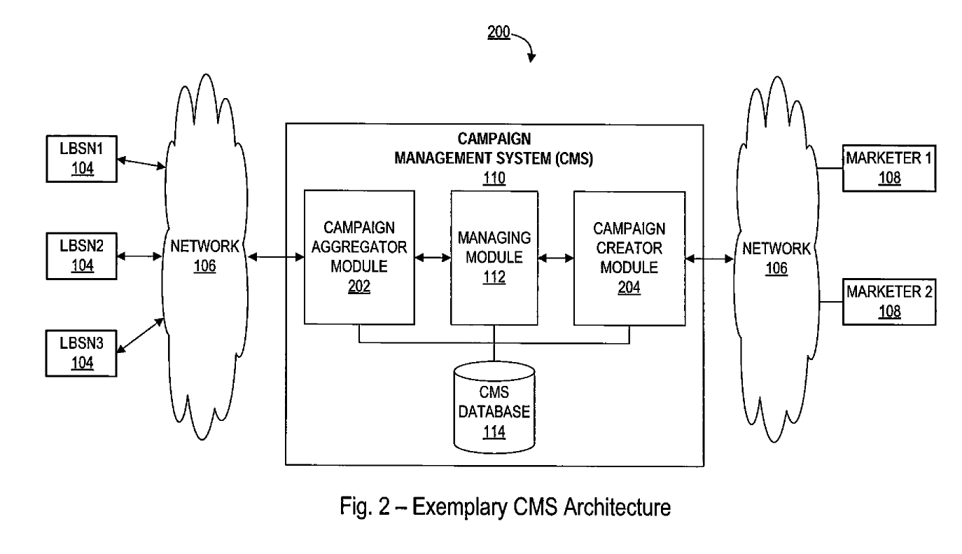

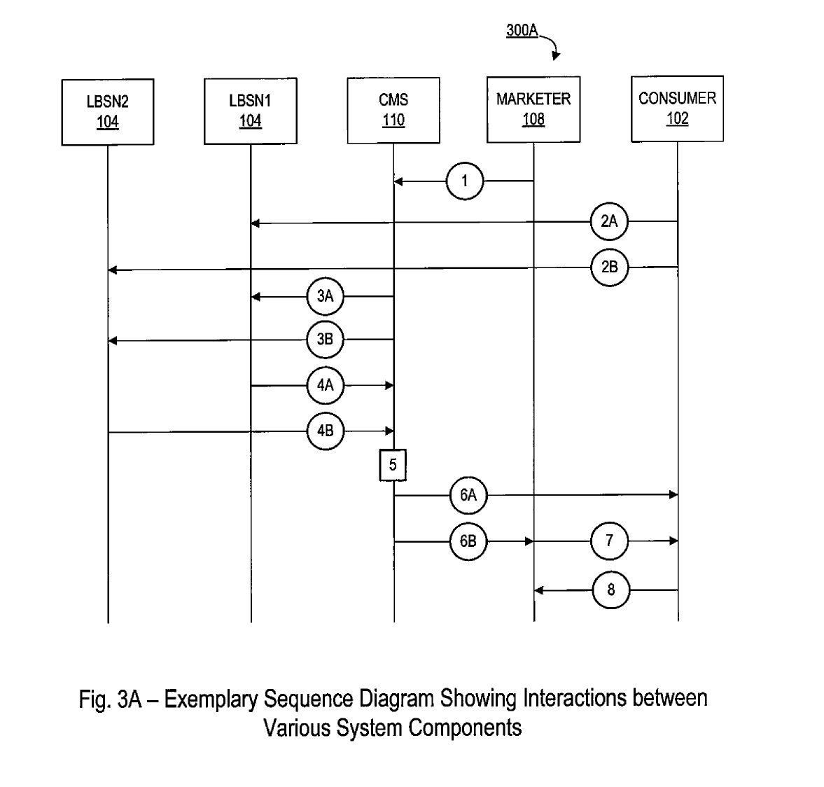

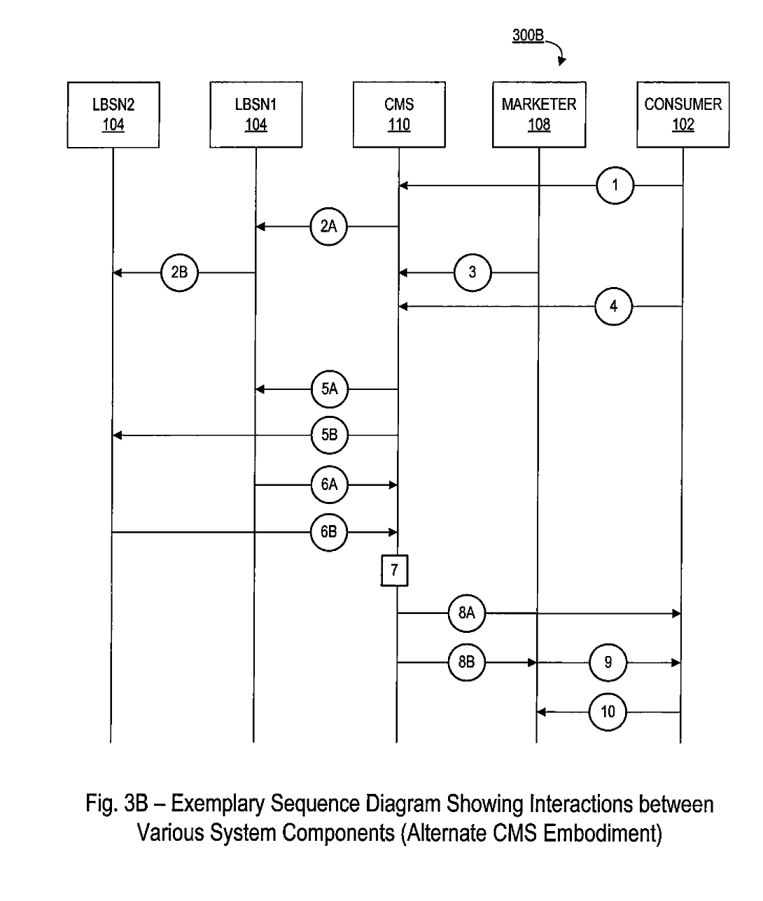

As will be understood, electronic communications involving various components such as the marketers 108, the CMS 110, consumers 102, LBSNs 104, typically proceed through a network 106 (such as the Internet), using one or the other services, such as a Web-deployed service with client/service architecture, a cellular network, a Local Area Network (LAN) or Wide Area Network (WAN), or through a cloud-based system. (Sequence diagrams displaying interactions between an embodiment of the CMS 110, LBSNs 104, marketers 106, and consumers 102 involved in delivering targeted marketing content to consumers based on a consumer's check-in information will be discussed in connection with FIGS. 3A and 3B.) Further, as will be understood and appreciated, various networking components like routers, switches, hubs, etc., are typically involved in the communications. Although not shown in FIG. 1, it can also be further understood that such communications may include one or more gateways/firewalls that provide information security from unwarranted intrusions and cyber attacks. Architectural details showing various software modules and engines comprising an embodiment of the CMS involved in delivery of targeted marketing content to consumers based on a consumer's check-in information will be discussed in detail in connection with FIG. 2. It will be understood that marketing offers, as used herein, includes any type of marketing content, and is not restricted to marketing offers only.

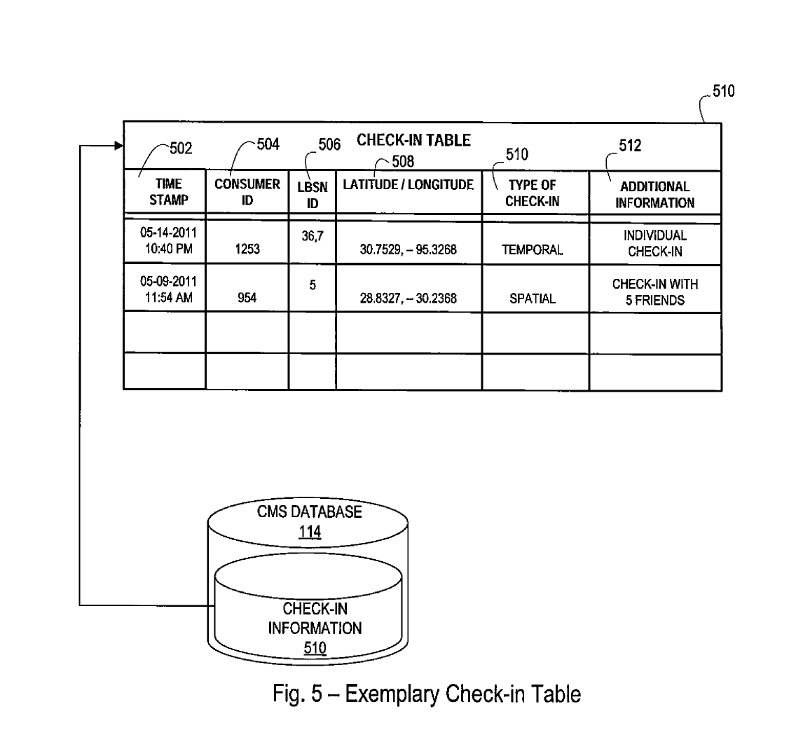

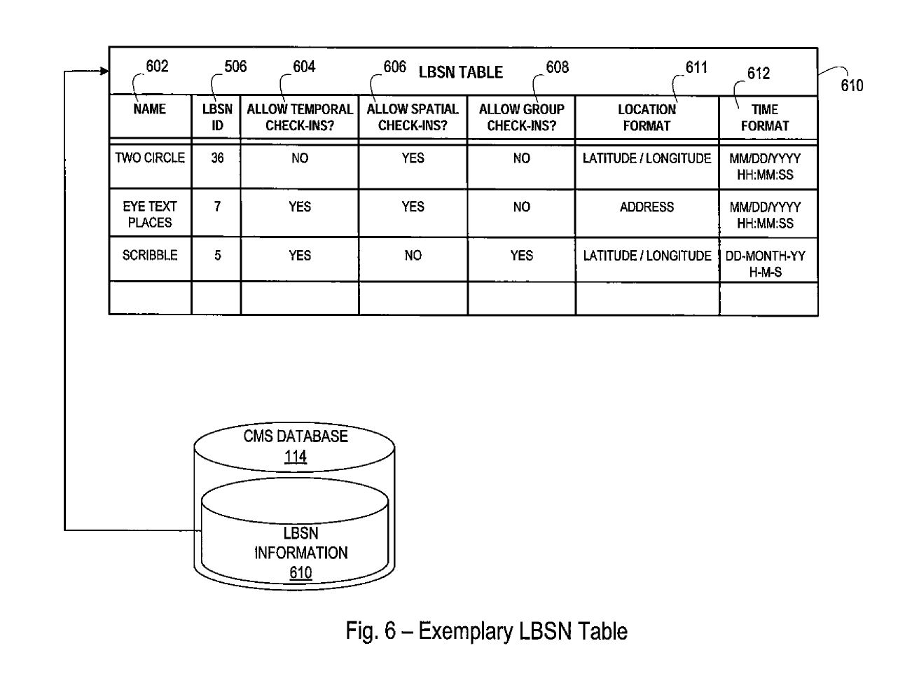

As shown in FIG. 1, it is shown that in one embodiment, the CMS 110 comprises a managing module 112 and an exemplary CMS database 114. As will be described in greater detail later herein, and in one exemplary aspect, the managing module 112 aggregates and manipulates a consumer's check-in information as obtained from a plurality of LBSNs. According to an embodiment of the present disclosure, a marketer's campaign related information, consumers' check-in information received from various LBSNs, and various other types of information are stored in the CMS database 114. For example, a data table showing various attributes (stored in CMS database 114) relating to check-in information, as received from various LBSNs by the CMS, is displayed in FIG. 5. Diverse types of data corresponding to various LBSNs are shown in FIG. 6.

Still referring to FIG. 1, after a consumer's check-in information is received at the CMS 110, the CMS 110 aggregates and manipulates the consumer's information with respect to a consumer's physical and/or temporal location. It will be understood and appreciated that LBSNs differ in the manner they provide check-in information to the CMS 110. For example, in one aspect, a geo-location can be provided (by a LBSN 104) in the form of a latitude/longitude co-ordinate. However, in another example, a LBSN 104 might provide a geo-location in the form of a street address. In an exemplary embodiment, various additional information can be provided by LBSNs 104, such as whether a consumer has checked in individually or with other persons in a group, and further identification information corresponding to who such persons are, the time at which a consumer checked-in, whether the consumer is attending a predetermined event, etc.

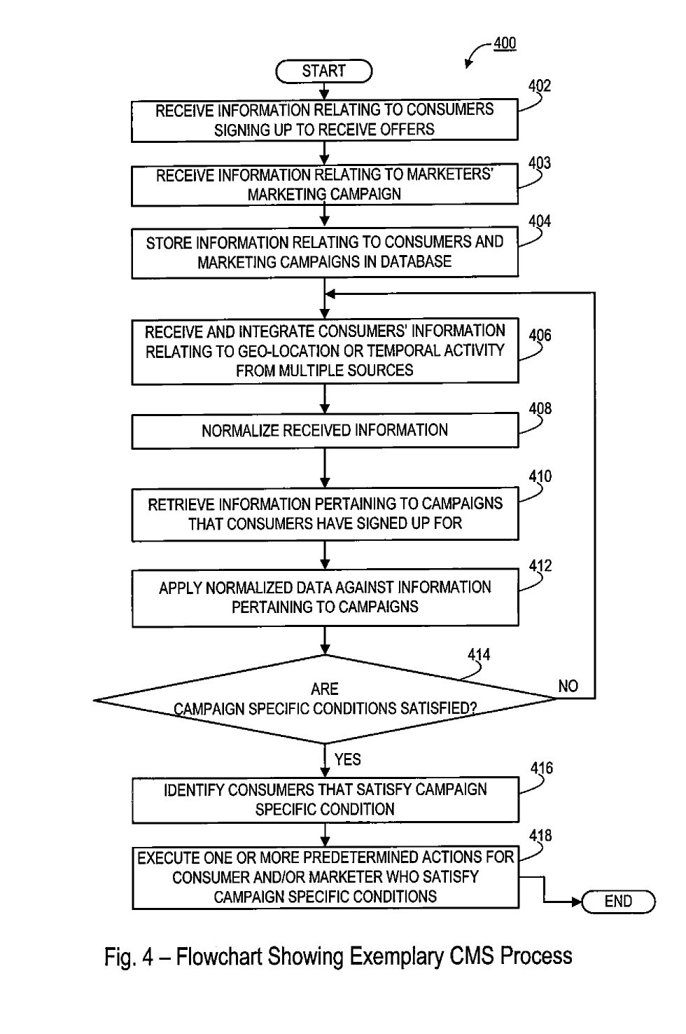

In one embodiment, check-in information received by the CMS 110 often comes from a plurality of heterogeneous sources, i.e., a variety of LBSNs and social media systems 104, each following their own file format. Further, each LBSN or social media system has its own policy of acquiring, storing, using, and redistributing check-in information. Thus, one embodiment of the present system “normalizes” the check-in information received from various disparate (heterogeneous) sources and different file formats into a common and proprietary format enables in storage, accumulation, and utilization of the information. Further, this normalization process enables targeted content associated with marketer's marketing campaigns to be delivered to consumers across a plurality of LBSNs from one integrated platform (e.g., the CMS 110). Details of a normalization process along with various other steps for purposes of fulfillment of the conditions of a marketing campaign as followed by the CMS 110 will be explained with the help of a flowchart in FIG. 4.

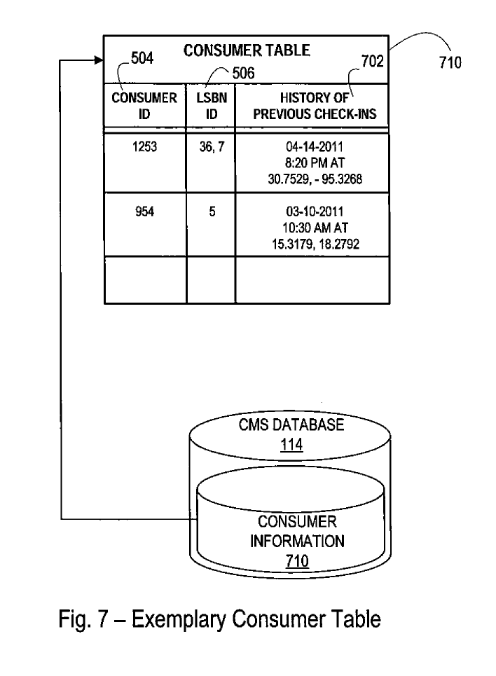

After the normalization process, the CMS identifies consumers who satisfy certain campaign-specific parameters/criteria. Examples of such parameters include whether consumers are at a specific geo-location, or whether consumers have checked in at a marketer's establishment a predetermined number of times, or whether consumers are attending a specific event, or any other such condition. An exemplary data table storing a history of consumers' check-in information is shown in connection with FIG. 7. Then, the CMS delivers pre-created, targeted marketing campaigns to the consumer via SMS, email or some other mechanism. Examples of such campaigns can involve online games, coupons, reward certificates, polls, loyalty points, promotional offers and the like. Thereafter, a consumer performs some action with respect to the campaign, and thereby fulfills the campaign. According to one aspect, such action is performed with a marketer. According to another aspect, such action is performed with the CMS.

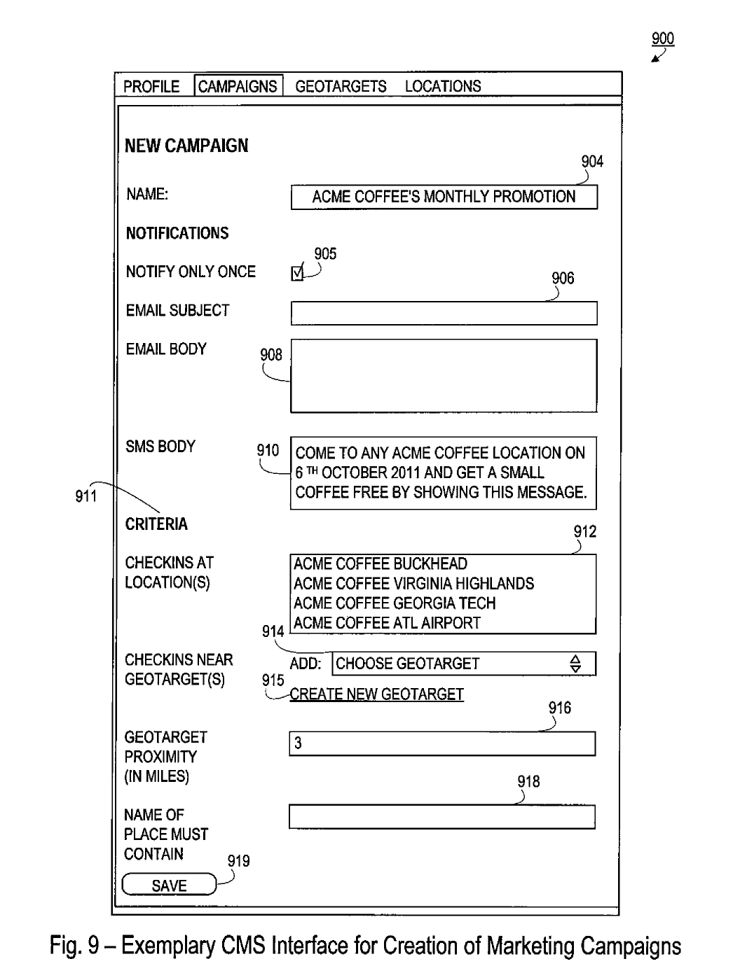

According to one embodiment of the present disclosure, the CMS 110 provides a platform to deliver targeted marketing content in order to encourage consumers 102 to buy goods and services from marketers 108. In one aspect, the CMS 110 provides an user-friendly graphical interface to marketers for creation of marketing campaigns, or review/edit of previously created campaigns. Such an exemplary interface is illustrated in FIG. 9. When creating a marketing campaign with targeted marketing content, the CMS 110 allows marketers 108 to specify target geo-locations such as their respective stores/retail establishments, or locations in close proximity to such target geo-locations. For example, a marketer might create a campaign (with the CMS) that dictates that if a consumer checks in at a geo-location corresponding to a marketer's retail establishment, or even within a predetermined physical radius of the marketer's retail establishment, then the consumer will receive (from the CMS) predetermined content created by the marketer. Correspondingly, in one exemplary scenario, consumers receive such content via SMS, email or any other mechanism with various deals, coupons, promotions, loyalty points for frequent check-ins, etc. on the consumer's mobile device. According to one aspect, such advertisements are presented to the consumer 102 by the CMS 110 according to the marketing campaign pre-created by the marketer 108. According to another aspect, such advertisements come directly to the consumer 102 from the marketer 108. Details of a CMS process for fulfillment of the conditions of a marketing campaign vis-à-vis delivering targeted marketing offers to consumers will be explained with the help of a flowchart in FIG. 4.

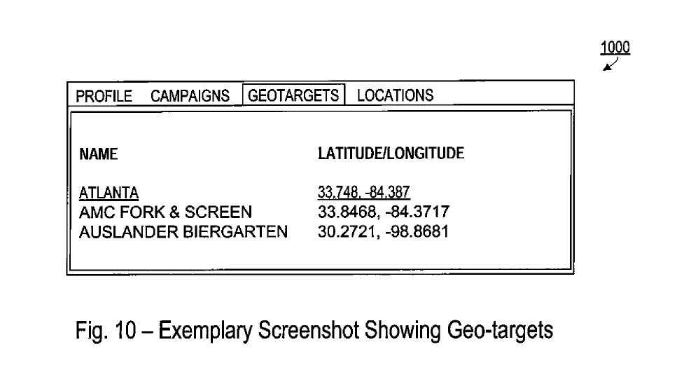

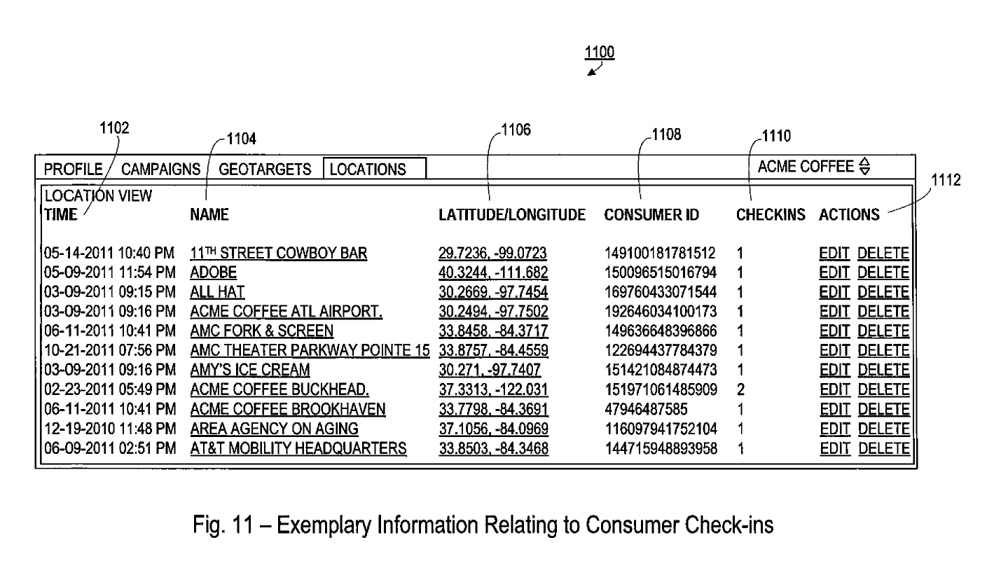

In several scenarios, campaigns created by a marketer comprise one or more criteria (requirements) that are to be matched (met) by the consumer, in order to receive targeted content. For example, as pre-specified by a marketer, a consumer might need to check in at a particular geo-location, or check-in more than a predetermined number of times, or any other condition. Usually, particular geo-locations pre-specified in a marketer's criteria for matching against consumers, are alternately referred to herein as geo-targets. An illustrative list of geo-targets specified by marketers and used by the CMS as campaign-specific matching criteria for purposes of delivery of marketing campaigns to consumers is shown exemplarily in FIG. 10. Furthermore, in many scenarios marketers desire to review information relating to consumer check-ins at various locations. Such information is displayed according to an exemplary screenshot as shown in FIG. 11.

Aspects of the present CMS 110 further allow marketers to customize their marketing campaigns according to marketer's preferences. For example, in order to promote greater engagement from consumers, the CMS 110 allows marketers to create custom marketing campaigns displaying “leader boards” that show real-time check-in counts as lists, charts, maps etc. to recognize leaders—by individual consumers or by location of a marketer's retail establishment.

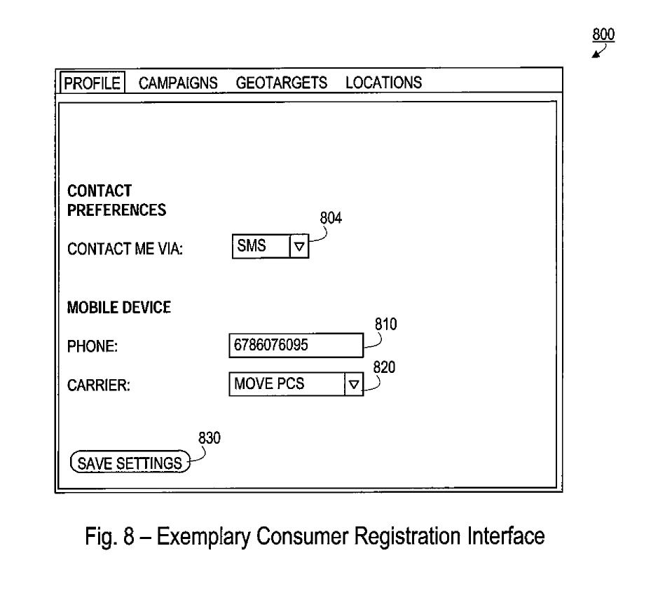

According to an exemplary aspect of the present disclosure, the CMS provides a registration interface that allows consumers to sign up to receive targeted marketing campaigns (pre-created by marketers) via email, SMS or some other delivery mechanism. A screenshot of an exemplary registration interface is displayed in FIG. 8. In the illustrations shown in the accompanying screenshots, and as will be seen herein for purposes of a discussion example, persons affiliated with a fictitious marketer (organization) called “Acme Coffee” creates and manages marketing campaigns on behalf of Acme Coffee. As will be shown, such persons will be able to specify (via a user interface) various campaign-specific requirements in terms of specific times and/or specific geo-locations corresponding to consumer activities that will be used by the CMS in delivering targeted marketing content to consumers.

The discussion above in association with FIG. 1 merely provide an overview of an embodiment of the present system for providing targeting content to consumers based on normalized information with respect to a consumer's physical location, and are not intended to limit in any way the scope of the present disclosure. For example, in an alternate embodiment, information identifying a consumer's geo-location is communicated directly to the CMS 110 without first informing the LBSN 104. Such an embodiment will be described in connection with FIG. 3B.

Turning now to FIG. 2, an exemplary CMS architecture 200 is shown comprising various software modules and components for performing functions of the CMS. As shown, the CMS communicates with a plurality of LBSNs 104 and marketers 108. According to one embodiment of the present disclosure, an embodiment of the CMS 110 is hosted on a third party physical server, or a cloud server. Although not shown in the embodiment in FIG. 2, it will be understood that a LBSN 104 contains software engines and modules that follow various standards, rules, and policies in connection with communication of consumers' check-in information. Further, these standards, rules, and policies often differ from one LBSN to the other. For example, a LBSN 104 may have specific configurations such as application programming interfaces (APIs) for developers and software programmers to access check-in information obtained by the respective LBSN. Or some other LBSNs may have strict privacy guidelines regarding the dissemination of consumers' check-in information. For example, a LBSN 104 might allow third party developers and software programmers to access consumers' check-in information after developers get the respective consumer's permission. Such a permission can be granted by a consumer via a registration process, wherein a consumer provides his or her phone number, and agrees to receive promotional offers from marketers and third party developers on the consumer's mobile device. Third party developers can henceforth perform authorized requests to receive the consumer's check-in information from the respective LBSN. Those skilled in the art will understand and appreciate that various functionalities in connection with a consumer's check-in information are often handled in different ways by different LBSN 104.

As shown in FIG. 2, the CMS 110 communicates with LBSNs 104 over a network 108 in order to receive information relating to a consumer's check-in at a geo-location. According to one embodiment, such a communication happens almost immediately after the consumer has checked in with the respective LBSN. In one embodiment of the present disclosure, communication between the CMS 110 and the LBSNs 104 occurs via APIs (Application Programming Interfaces) developed by the LBSNs, the CMS, or a third-party developer.

According to an embodiment of the present disclosure, the CMS 110 further comprises several software modules, for example, a campaign aggregator module 202, a managing module 112, and a campaign creator module 204. Details of such modules will be described in what follows next. As will be understood and appreciated, embodiments of the present disclosure are not limited to such modules.

Generally, information relating to a consumer's check-in at a geo-location is collected by a campaign aggregator module 202, as received from various LBSNs. As recited previously, a variety of LBSNs 104 provide information relating to consumers' check-in information, each LBSN following its own file format, and differing in the attributes that comprise the check-in information. Moreover, each LBSN (or social media system) has its own policy of acquiring, storing, using, and redistributing check-in information. Those skilled in the art will understand and appreciate that there is a need to “normalize” the check-in information received from various disparate (heterogeneous) LBSNs and different file formats into a common format that enables in storage, accumulation, and utilization of that information. Specifically, in one embodiment, in order to identify consumers that satisfy the parameters/criteria specified in the targeted content created by marketers, details associated with consumers' check-ins should be standardized into a common format. For example, a consumer might check in through a LBSN that identifies a check-in in MM/DD/YYYY format, whereas another LBSN uses a YYYY/MM/DD format. In one exemplarily embodiment, such a normalization process is performed by a managing module 112. Details of a normalization process along with various other steps for purposes of fulfillment of the conditions of a marketing campaign as followed by the CMS 110 will be explained with the help of a flowchart in FIG. 4. In addition, managing module 112 performs several tasks, for example, processing various criteria and parameters for matching requirements of marketing campaigns. Further, managing module 112 generates various analytics in connection with evaluating the effectiveness of targeted marketing offers to consumers, and further displaying results of such an evaluation.

In one embodiment, a campaign creator module 204 processes information and tasks related to a marketer's campaign that enables marketers to construct highly-relevant advertisements and marketing offers that will be displayed on consumers' mobile devices, or other check-in devices. Examples of such tasks include creation of various offers (such as loyalty-points rewards, coupons and the like), polls, promotions, and eligible conditions associated with the marketing campaigns. An exemplary screenshot of a campaign creation interface as displayed to marketers is shown in FIG. 9.

Still referring to FIG. 2, a CMS database 114 is generally used to store campaign-related data received from marketers by a campaign creator module 204, information relating to a consumers' check-ins at geo-locations collected by a campaign aggregator module 202, and data generated during intermediate stages of processing by a managing module 112. The modules and software engines discussed in connection with FIG. 2 are for exemplary purposes only, alternate embodiments are not limited to the specific modules and software engines discussed herein. For example, although FIG. 2 illustrates three distinct modules, in an alternate embodiment, the functionalities of the campaign creator module 204, campaign aggregator module 202, and managing module 112 can be combined into a single or even multiple module(s), possibly with other functionalities as will occur to one of ordinary skill in the art. Even further, various other types of information can be stored in the CMS database 114, and are not limited to the ones described herein. Interactions involving the CMS 110 and various components of an embodiment of the present system for providing targeting marketing offers to consumers based on aggregating information with respect to a consumer's physical location from one or more LBSNs will next be described with the help of a sequence diagram.

Now referring to FIG. 3A, a sequence diagram 300A is shown illustrating interactions between LBSNs, an embodiment of the CMS 110, a marketer 108, and a consumer 102. Starting at step 1 in FIG. 3A, a marketer utilizes an embodiment of the CMS 110 to create a marketing campaign, usually to reach out to new consumers, based on general consumer activity (such as consumers' check-in information) obtained from a plurality of LBSNs 104. In another aspect, marketers can create marketing campaigns by leveraging their existing consumer base. In such scenarios, the CMS tracks the activities of individual consumers in the marketer's consumer base when those consumers check-in at various venues.

At exemplary steps 2A and 2B, a consumer checks in at a geo-location using LBSN1 or LBSN2 respectively. As will be understood, no limitation is imposed on the number of LBSNs that a consumer may use to check-in. Specifically, two LBSNs are shown in FIG. 3A for illustrative purposes only. But one of ordinary skill in the art will understand that a virtually unlimited of LBSNs may be incorporated in various embodiments of the present system. It is a consumer's preference to be registered with a LBSN, and no limitation is imposed on a particular type of LSBN with which the consumer may be registered. In one alternate embodiment of the present disclosure, a consumer can check-in at a geo-location using the CMS 110. Further details of such an embodiment will be discussed in connection with FIG. 3B. As recited previously, a check-in as referred to herein comprises a generic social activity performed by a consumer (to inform the outside world, or for a consumer's personal tracking), with respect to specific times (temporal event) and/or specific geographical locations (spatial event). For example, if a consumer checks in at a restaurant or a coffee shop, then such an event may be considered as a spatial event. On the other hand, if a consumer checks in at a concert (i.e., as an event, and not necessarily the venue of the concert), then such an event may be considered as a temporal event. Accordingly, in one aspect, the present CMS is able to correlate between spatial and temporal events. For instance, if a consumer checks in at a bar (spatially), and there is a band performing at the bar (temporal event), sponsors of the performance can reach out to the consumer (via the CMS) even if the consumer is unaware of the band's performance, and/or the sponsors of the performance.

In another scenario, aspects of the present disclosure allow marketers to reach out to consumers checking in with different LBSNs. For example, a group of consumers comes to a bar together and there is a concert performance at the bar, and moreover, consumers check-in as a group, although with different LBSNs. Then, in such instances, the CMS is able to obtain group check-in information of the consumers from various LBSNs. Consequently, sponsors of the concert are able to reach out to consumers and correlate between spatial and temporal check-ins, even with check-in information obtained from different LBSNs.

Following the consumer's check-in (spatial or temporal), the CMS 110 requests (at steps 3A and 3B) information relating to the consumer's check-in from LBSN1 and LBSN2 respectively. As will be understood, because the CMS 110 is unaware of the consumers' check-in until the information is received from the LBSNs, the CMS will typically query the LBSNs on a periodic or virtually continual basis. Further, in one embodiment, the LBSNs will push information to the CMS at steps 3A and 3B rather than the CMS having to request such information. Accordingly, the respective LBSNs respond with information relating to the consumer's check-in at a geo-location at steps 4A and 4B respectively. Check-in information typically comprises a point-of-interest (i.e., a geo-location), a time stamp corresponding to a check-in, and a Consumer ID (or, equivalently a User ID) identifying a consumer uniquely. In addition to the above, various LBSNs can provide other information relating to the check-in, such as, if a consumer checked in individually or as a group, the number of friends of the consumer who have also checked-in at that location or the event etc. Exemplary data tables storing various attributes related to check-ins, LBSNs, and consumers are shown in connection with FIGS. 5-7.

After receiving a consumer's check-in information, the CMS 110 normalizes the check-in information received (at step 5) from one or more LBSNs 104. As recited previously, the check-in information typically differs in content, file format and hence the CMS 110 normalizes the check-in information received from various disparate (heterogeneous) sources into a common standard format that enables in storage, accumulation, and utilization of such information in a standardized manner. Details of a normalization process along with various other steps for purposes of fulfillment of the conditions of a marketing campaign as followed by the CMS 110 will be explained with the help of a flowchart in FIG. 4.

Subsequently, it is shown in FIG. 3A that at steps 6A and 6B, the CMS executes one or more predetermined actions for consumers and marketers respectively, corresponding to fulfillment of various conditions in the pre-created marketing campaign. For example, if a marketer creates a marketing campaign wherein a consumer earns fifty (50) loyalty points for checking in at a marketer's retail establishment, then the CMS notifies the consumer and the marketer of the consumer's recent check-in and loyalty points balance. Or, in another illustrative example, a marketer might create a campaign wherein a consumer received a free drink at a bar after the fifth check-in at a marketer's retail establishment. Correspondingly, in such a scenario, the CMS verifies the total number of check-ins accumulated by the consumer over time, and provides that information to the marketer. An exemplary marketing campaign creation interface is shown in FIG. 9.

In one embodiment, the CMS provides (at step 6B) the marketer with information relating to the consumer's check-in activity, and then at a following step 7, the marketer takes some action with respect to the consumer based on the information received from the CMS. For example, a marketer can send emails and SMS messages with various promotional offers, coupons, polls, etc. to the consumer based on the check-in information. At step 8, the consumer takes some action, in response to the marketer's action at previous step 7. Actions taken by a consumer will be better understood with the following exemplary scenario. For example, if a consumer's check-in information indicates that the consumer is at a location (or, in the vicinity of a location) specified in a marketer's marketing campaign, then the consumer receives targeted marketing content, such as a discount coupon along with instructions to redeem such a coupon. Accordingly, a consumer can redeem that coupon by following the instructions provided, which can involve travelling to a marketer's retail location and showing the coupon.

Although not shown in FIG. 3A, it will be understood that in alternate embodiments, a consumer can take actions with respect to the CMS as well. An exemplary scenario when a consumer performs an action with respect to the CMS is when a consumer responds to polls, surveys, etc. transmitted by the CMS. In another scenario, consumers might be included in playing interactive games with other consumers, wherein the gaming system is hosted on the CMS platform. Accordingly, consumers will provide interactive inputs (as a part of playing) the game, which will be received by the CMS.

Although, the description of FIG. 3A comprises a single consumer and a single marketer, no such limitation is imposed. Alternate embodiments of the CMS can have multiple marketers providing targeted marketing content to multiple consumers, wherein information with respect to a consumer's physical location can be obtained from a variety of LBSNs, via a single CMS platform.

Now referring to FIG. 3B, a sequence diagram 300B is shown illustrating interactions between LBSNs, an embodiment of the CMS 110, a marketer 108, and a consumer 102. In this alternate embodiment, the CMS is able to leverage some functionalities of a LBSN in such a manner that a consumer is able to check-in at a geo-location using the CMS, wherein a LBSN is presented with the consumer's check-in information by the CMS. Further details of this embodiment will be described in greater detail in the following description.

Starting at step 1 in FIG. 3B, a consumer signs up (registers) with the CMS to receive marketing offers via SMS and/or email. In one aspect, a consumer also provides to the CMS a selection comprising one or more LBSNs of which the consumer is a member or intends to be a member. In this embodiment, it is assumed that a consumer has chosen to be members of LBSN1 and LBSN2. In an example, a consumer might decide to choose LBSNs that are more popular than others. In another example, a consumer might choose LBSNs based on the advice of his or her friends and family members. Then, at steps 2A and 2B, the CMS 110 provides an indication to the respective LBSNs that the CMS would be monitoring the check-ins for this consumer.

At step 3, a marketer 108 utilizes an embodiment of the CMS 110 to create a marketing campaign or other content that utilizes consumers' check-in information. (An exemplary marketing creation interface is shown in FIG. 9.) Then, at step 4, a consumer checks-in at a geo-location using the CMS. As described previously, a consumer might check-in using a mobile device, cell phone, or other check-in device. At steps 5A and 5B, the CMS transmits information relating to a consumer's check-in at a geo-location to the respective LBSNs. In one aspect, the CMS also requests additional information from the respective LBSNs. Examples of such additional information comprise check-in information of a consumer's friends, family members etc. In turn, the respective LBSNs respond back with the requested information at steps 6A and 6B respectively. It will be understood and appreciated that a benefit of this embodiment is that a consumer does not need to sign up with multiple LBSNs, and hence a consumer does not need to stay logged into various LBSNs.

After receiving additional information from the LBSNs, the CMS 110 normalizes (at step 7) the information received from the LBSNs 104. Subsequently, at step 8A and 8B, the CMS executes one or more predetermined actions for consumers and marketers respectively, corresponding to fulfillment of various conditions in the pre-created marketing campaign. Then, at step 9, a marketer takes some action with respect to the consumer, and finally at step 10, the consumer takes some actions with respect to the marketer, such as completes a transaction, takes advantage of some promotions, etc. Exemplary scenarios illustrating predetermined actions taken by the CMS have been discussed earlier in connection with FIG. 3A. Further, corresponding actions taken by the consumers and marketers in response to the CMS's predetermined actions have also been illustrated. Exemplary data tables storing various attributes related to check-ins, LBSNs, and consumers are shown in connection with FIGS. 5-7. Detailed steps describing an exemplary CMS process will be described next.

Now turning to FIG. 4, an exemplary Campaign Management System (CMS) process 400 is shown for purposes of offering targeted marketing content based on users of a plurality of LBSNs from a single CMS platform, based on the users' check-in information. As will be understood, the steps of the process 400 shown in FIG. 4 are not necessarily completed in the order shown, and various steps of the CMS may operate concurrently and continuously. Accordingly, the steps shown in FIG. 4 are generally asynchronous and independent, computer-implemented, tied to particular machines (including various modules/engines of the CMS 110, coupled to databases), and not necessarily performed in the order shown.

As recited previously, in one embodiment, aspects of the present disclosure involve aggregation, manipulation, and management of diverse types of information relating to consumers' social activities, as obtained via a plurality of location based social networks (LBSNs). Information relating to consumers' social activities is collected by one or more LBSNs, and further broadcast to other members of the LBSN, or the consumer's social networks of which the consumer is a member. In one exemplary aspect, information relating to a consumer's social activities includes a consumer's geo-location in real time, corresponding to a location where the consumer checked-in with one or more LBSNs, wherein the consumer is a member of one or more LBSNs. In one example, if a consumer's geo-location check-in corresponds to one or more physical locations pre-specified by marketers in their marketing campaigns, then a consumer receives targeted marketing content from marketers. Generally, consumers check-in using their mobile device such as mobile phones, tablet PC, etc. and thus, receive targeted marketing content from marketers on the respective mobile device. Aspects of the present disclosure are also related to creating and managing targeted marketing content, and further the delivery of such content to consumers based on satisfaction of criteria provided by marketers in their targeted marketing content, with information related to consumer check-ins.

Starting at step 402, an embodiment of the CMS receives information relating to a consumer's registration to receive marketing offers involving the CMS. It will be understood that in various alternate embodiments, a consumer can register with one or several of the following: the CMS, a marketer, or a LBSN. An exemplary consumer registration interface is displayed in FIG. 8. In alternate embodiments, consumers are automatically signed up to receive offers from the CMS, when they sign up with a LBSN or a marketer. In addition, at step 403, the CMS also receives information relating to a marketing campaign created by a marketer. An exemplary marketing campaign creation interface is displayed in FIG. 9. At next step 404, information that was received previously is stored in an exemplary CMS database for further processing.

Subsequently, when a consumer who is a member of a respective LBSN checks-in at a location, or even in some cases, in the vicinity of the location corresponding to participating marketers, information relating to the consumer's check-in is relayed by the LBSN to the CMS, after the LBSN receives (not shown in FIG. 4) a request for such information from the CMS. According to one embodiment, consumers check-in via one or more LBSNs corresponding to a temporal or spatial event, using a mobile device. In one embodiment of the present system, it will be understood that a check-in by a consumer at a geo-location involves a real-time communication of the consumer's current location to a respective LBSN. Thus, at step 406, the CMS receives and integrates information from one or more LBSNs corresponding to the consumer's check-in for a spatial activity (for example, at a geo-location or in the vicinity of one), or a temporal activity. Check-in information typically comprises a point-of-interest (i.e., a geo-location), a time stamp corresponding to a check-in, and a Consumer ID (or, equivalently a User ID) identifying a consumer uniquely. In addition to the above, various LBSNs can provide other information relating to the check-in, such as, if a consumer checked in individually or as a group, the number of friends of the consumer who have also checked-in, etc. Exemplary data tables storing various attributes related to check-ins, LBSNs, and consumers are shown in connection with FIGS. 5-7.

As recited previously, the check-in information from various LBSNs often differs in content, file format, transmission method, identifiers, and the like. Thus, the CMS 110 normalizes the check-in information received from various disparate (heterogeneous) sources into a common standard format that enables in storage, accumulation, and utilization of such information. Hence, at step 408, the CMS normalizes the received information. Generally, a normalization process involves mapping received check-in information to a common predetermined format, and then storing the information in appropriate columns (or, equivalently column headers) in a database for storage and further processing of such information, and is further explained below with an example.

In one instance, one LSBN provides consumers' check-in locations in the form of latitudes/longitudes, whereas another LSBN provides check-in information in the form of physical street addresses. Consequently, the CMS 110 parses the information received from the LBSNs, determines the information received and its type, and thereafter assigns the received check-in information to proper columns in a data table for storage in the CMS database. According to one aspect, a normalization process is automatically performed according to instructions in a template file. As will be understood, such a template file is a document containing instructions of a normalization process, i.e., mapping types of LBSN-provided information to appropriate corresponding, predetermined types of information in a CMS database. Generally, a template file can be created for each individual LBSN that the CMS receives consumers' check-in information from. It will be understood that this approach of creating a template file is a more “static” one, wherein the LBSN informs the CMS of the types and formats of the columns/fields and the underlying data, and consequently the CMS, in turn, creates a template file. This approach also includes the possibility of the LBSN generating a list of commonly used types and formats of the columns/fields and the underlying data.

In another instance of a normalization process, the CMS parses the check-in information received from the LBSNs dynamically without a template file. In this instance, a predetermined list of search terms might be created by a CMS administrator, and then compared against terms extracted from check-in information. For example, if the CMS identifies a name of a month in the check-in information, then the system will understand that the information in that data item likely correlates to a date. Thus, the CMS can map that particular data item to the an appropriate predetermined types of information in the CMS database.

Following a normalization process, the CMS retrieves (at step 410) information pertaining to one or more marketing campaigns from the CMS database. (It will be recalled that such information was received by the CMS from marketers at an earlier step 403.) Next, at step 412, the CMS compares normalized data against the information pertaining to one or more campaigns, as provided by marketers previously. Information pertaining to one or more campaigns typically comprises various criteria/parameters that must be satisfied by consumers' check-in information in order for the respective consumers to receive targeted marketing content.

In one aspect, several marketers can collaborate to create joint marketing campaigns for delivery of targeted marketing content to consumers. Examples of marketing campaigns comprise geo-location-based coupons, deals, loyalty points for consumers' activities, polls, interactive games, and the like. It will be understood that step 412 involves computer-implemented aspects of data mining, data comparison, and several other computer methodologies as will occur to one skilled in the art.

At next step 414, the CMS verifies whether or not specific marketing conditions (criteria) specified in the marketing campaigns are satisfied by the consumers' check-in information, by utilizing the normalized check-in information and the information pertaining to one or more marketing campaigns. For example, in one instance, geo-targets identified by marketers are used as a matching criteria by the CMS for purposes of delivery of marketing campaigns to consumers. In other words, those consumers who check-in at the geo-targets specified by marketers, or in a pre-determined vicinity of the geo-targets specified by marketers, will receive targeted marketing campaigns created by the marketer, from the CMS. An exemplary marketer called Acme Coffee can create a marketing campaign for an existing location such as an airport, and can further limit the campaign to a specific airport by adding a name such as “Hartsfield Airport.” Thus, if a consumer checks in at any other airport besides “Hartsfield Airport”, then the consumer will not receive the marketing campaign. As will occur to one of ordinary skill in the art, in alternate embodiments of the CMS, marketers can specify various other campaign-specific requirements such as a time of the day, or even a combination of a target time and a geo-location, an age or sex of the consumer, consumer preferences to receive specific kind of offers/campaigns, and possibly many other variations. A list of geo-targets specified by marketers and used by the CMS as campaign-specific matching criteria for purposes of delivery of marketing campaigns to consumers is shown exemplarily in FIG. 10.

On the basis of the verification in step 414, at following step 416, the CMS identifies consumers that satisfy campaign-specific requirements (matching criteria). If the outcome of the verification in step 414 indicates that consumers do not satisfy campaign-specific requirements, then the process reverts back to step 406, and the CMS waits for information relating to consumers' check-in from various LBSNs, and the process repeats thereafter. If, however, the results of step 416 indicate that one or more consumer check-ins satisfy the conditions of one or more targeted marketing offers, then at step 418 the CMS executes one or more predetermined actions with respect to consumers and/or marketers based on consumers who satisfied (at step 416) campaign-specific conditions. In an embodiment, the CMS sends to the consumers emails and SMS messages with various promotional offers, coupons, polls, interactive games, etc. In another embodiment, the CMS conveys to the marketer information relating to the consumer's check-in activity so that the marketer takes some action with respect to the consumer. (Information relating to consumers' check-in activities as obtained from various LBSNs, is displayed to marketers as shown exemplarily in FIG. 11.)

In one scenario, a consumer who checks-in at a geo-location (or in the vicinity of a geo-location) might satisfy conditions specified by multiple marketers. For example, a consumer who checks in at a downtown Atlanta location might satisfy conditions specified by several restaurants (marketers) that are located within a certain physical radius of the consumer's current location, e.g., marketers that have defined geo-targets corresponding to certain radii around a given physical location, such as a building, zip code, or any other geographical identifier. In such a scenario, and according to one embodiment, the CMS determines particular marketing offers (or, a particular predetermined sequence of marketing offers) that will be presented to consumers. For example, the entity which hosts the CMS might rank marketers according to a sequence wherein the revenue they pay such an entity directly corresponds to their rank in the sequence. In another example, a list of marketers are presented to a consumer based on the distance between a marketer's retail establishment and the consumers' current location. In another embodiment, the CMS delivers marketing offers for all such marketers whose conditions are satisfied by the consumer's check-in information and allows the consumer to choose one or more of such offers.

It will be understood that the steps discussed in connection with the above flowchart are provided for illustrative purposes only, and are not intended to limit the scope of the present disclosure in any way. Alternate embodiments of the CMS can involve variations of the steps discussed herein, for example, the CMS can allow consumers to check-in corresponding to a temporal activity. Information related to consumer check-ins, LBSNs, etc., will be better understood with exemplary data tables that will be described in the following discussions.

Now referring to FIG. 5, an exemplary check-in table 510 (stored in a CMS database) is shown illustrating various attributes related to a consumer's check-in at a target geo-location, as relayed by an LBSN 104 to the CMS 110. According to one embodiment, such information is processed according to the steps described in FIG. 4 to provide targeted marketing offers to consumers.

As shown in FIG. 5, a “Time Stamp” column 502 stores a date and time when the check-in activity occurred for a consumer (uniquely represented by an identifier in a “Consumer ID” 504). According to one aspect, check-in activity for a consumer is obtained via one or more LBSNs that are identified uniquely according to the attributes stored in the “LBSN ID” column 506. Specifically, in one embodiment, each LBSN that is operatively connected to the CMS 110 has a unique LBSN ID. Further, a geo-location corresponding to each consumer's check-in is stored in a “Latitude/Longitude” column 508. Although not shown in FIG. 5, it will be understood that a geo-location can also be identified according to a street address, or any other physical identifier. In one aspect, the CMS receives check-in information in various formats which is subsequently normalized according to a normalization process. Details of such a normalization process and an example were described previously in connection with FIG. 4.

As recited previously, information in connection with a person's social activities at any time or geographical location, is alternately referred to herein as a check-in. For example, when a person is at a venue such as a restaurant, then the consumer (or, a consumer's electronic mobile device) performs a spatial check-in at the restaurant. In another example, a person can inform a LBSN via a temporal check-in such as a football game that the person will attend on a specific future date. Thus, a column 510 entitled “Type of Check-in” identifies whether a particular check-in corresponds to a spatial or a temporal check-in. Additionally, it will also be recalled from the previous discussions that a LBSN can provide additional information along with a consumer's check-in information. Such additional information is stored in an “Additional Information” column 512 in the check-in table. Exemplary additional information comprises an indication of whether a consumer's check-in was an individual check-in, or alternatively a group check-in with the consumer's friends on the respective LBSN.

As shown exemplarily in FIG. 5, on May 14, 2011 at 10:40 pm, a consumer with Consumer ID 1253 checked in with two LBSNs having LBSN IDs 36 and 7. This check-in was corresponding to an exemplary geo-location identified as 30.7529 and −95.3268 in terms of geographical latitude and longitude coordinates respectively. Also, this particular check-in comprises an individual check-in involving the consumer only, and corresponds to a temporal event (for example, a concert or a football game). As will be understood, information stored in a check-in table is typically provided by LBSNs. Exemplary LBSN-related information comprising various descriptive attributes of LBSNs as stored in a LBSN table, will be described next. It will be understood that the types of data and information shown in check-in table 510 are presented merely for illustrative purposes only, and other types of data/columns may be included, and further in different formats.

Now referring to FIG. 6, an exemplary LBSN table 610 (typically stored in an exemplary CMS database) is shown describing exemplary data stored in connection with various LBSNs. For example, a “Name” column 602 stores the name of LSBNs that provide consumers' check-in information to the CMS, and a “LBSN ID” column 506 stores unique identifiers corresponding to the LSBNs in the Name column. Also, an “Allow Temporal Check-ins” column 604 and an “Allow Spatial Check-ins” column 606 store information indicating a yes/no corresponding to whether a LBSN allows consumers to perform temporal and spatial check-ins respectively. Additionally, an “Allow Group-check ins” column 608 stores information indicating a yes/no corresponding to whether or not a LSBN allows group check-ins or not.

As recited previously, a LBSN can provide a geo-location in the form of a latitude/longitude, or a street address, or any other location identification information to the CMS. This is indicated by a “Geo-location Format” column 611 in the LBSN table. A “Time Format” column 612 indicates the format in which a LBSN communicates time information to the CMS.

As shown in FIG. 6, exemplarily a LSBN called Two Circle identified by a LBSN ID 36 does not allow temporal check-ins to consumers, but allows spatial check-ins, and also does not allow group check-ins. Also, exemplarily it is shown that the LSBN called Two Circle provides a geo-location in the form of a latitude/longitude combination. Further, it is shown that the format in which date and time information are provided to the CMS is in the form of MM/DD/YYYY and hh:mm:ss respectively. As will be understood, information relating to LBSNs and their information formats can be stored in the LBSN table in different predetermined formats. It will be recalled that the check-in information from various LBSNs often differs in content, file format, transmission method, identifiers, and the like. Thus, the CMS normalizes the check-in information received from various disparate (heterogeneous) sources into a common standard format that enables in storage, accumulation, and utilization of such information. Detailed steps of a normalization process have been described earlier in connection with FIG. 4. In one aspect, a LBSN table, such as the exemplary LBSN table 610 is used as a reference table to normalize check-in information received from various LBSNs into predetermined formats.

In what follows next, a consumer table storing exemplary attributes stored in connection with consumers or users of the present system will be described. It will be understood that the types of data and information shown in LBSN table 610 are presented merely for illustrative purposes only, and other types of data may be included, as will occur to one skilled in the art.

Referring to FIG. 7, an exemplary consumer table 710 is shown displaying information relating to consumers or users of an embodiment of the present system. As described previously, in one embodiment, consumers will have previously provided information to the CMS 110 indicating the consumers' LBSN memberships or associations. As shown in FIG. 7, a “Consumer ID” column 504 displays a consumer ID (or, equivalently a User ID) identifying a consumer uniquely, the consumer being associated with one or more LBSNs as specified in the “LBSN ID” column 506. Further, a column entitled “History of Previous Check-ins” 702 stores information corresponding to a consumer's prior check-ins with the respective LBSNs that are specified in the LBSN ID column. Generally, the History of Previous Check-ins column stores specific dates, times, geo-locations, and other relevant information corresponding to a consumer's social check-in activity. For example, a consumer having a consumer ID 1253 is associated with two (2) LBSNs, identified with LBSN ID 36 and 7, the consumer having checked in at a geo-location with latitude/longitude 30.7529, −95.3268 on Apr. 14, 2011 at 8:20 pm. Although not shown in FIG. 7, it will be further understood that various additional information can also be stored in the “History of Previous Check-ins” column, or in additional columns in this data table. As recited previously, check ins are typically used to determine various matching of campaign-specific conditions pre-determined by marketers for purposes of receiving targeted marketing campaigns. According to one embodiment of the present disclosure, a consumer can register his or her mobile device (for example, a mobile phone or a tablet PC) to receive targeted marketing campaigns from various marketers via the CMS. Such a registration interface is described in what follows next.

Now referring to FIG. 8, an exemplary screenshot 800 of a consumer registration interface of the CMS is shown. As shown in FIG. 8, a drop down menu 804 allows consumers to choose the method(s) in which the consumers will receive targeted marketing content from consumers. If, for example, consumers have indicated a selection for a SMS using drop down menu 804, the CMS displays a box 810 for a consumer to type in his or her mobile device number. Also, in one embodiment, a consumer indicates to the CMS, the name of a wireless carrier corresponding to the consumer's mobile device via drop down “Carrier” menu 820. It will be understood that the CMS typically uses the name of a wireless carrier to identify a network gateway address of a wireless carrier, such a gateway being used to route messages electronically from the CMS (or, the marketer) to a consumer's mobile device. As seen exemplarily in FIG. 8, a consumer has indicated a mobile phone number has 6786076095, and a wireless carrier as MovePCS.

It will be understood by one of ordinary skill that if a consumer indicates that he or she wishes to receive offers via email using drop down menu 804, then a box is displayed for a consumer to type in his or her email address. As will be understood, various other contact mechanisms are possible, such as delivery of targeted content through MMS, social media posts, hard copy mail, and the like. After a consumer has entered information through the interface (exemplarily displayed in screenshot 800), and has clicked on “Save Settings” button 830, the CMS stores such information in an exemplary CMS database, for purposes of communicating targeted marketing campaigns to the consumer. Although not shown in FIG. 8, it will occur to one of ordinary skill in the art that various other information can be entered by a consumer through a registration interface. Examples of such information include names of various LBSNs of which the consumer is a member, preference of consumers to receive particular types of marketing campaigns, and various other information. A CMS interface that allows a marketer to create targeted marketing campaigns will be described next.

Now referring to FIG. 9, an exemplary screenshot 900 of a CMS interface for creation of marketing campaigns is displayed. In a hypothetical scenario, a person affiliated with a marketer called Acme Coffee intends to create a marketing campaign for consumers on behalf of Acme Coffee. As shown in FIG. 9, a name of a marketing campaign is entered through a “Name” box 904. Exemplarily, the campaign as displayed in screenshot 900 is named Acme Coffee's Monthly Promotion.

According to one aspect, a person affiliated with a marketer can specify to the CMS a number of times a notification containing the marketing campaign will be sent out to consumers. Such a selection is entered through a check-box 905 (entitled “Notify Only Once”) as displayed on screenshot 900. In one aspect, the CMS automatically determines that notifications will be sent to consumers a fixed number of times. In another aspect, the CMS allows marketers to choose such a number. As recited previously, marketers can deliver targeted marketing campaigns to consumers via email, or SMS or some other communication mechanism. Therefore, to enable marketers to send marketing campaigns via email, an “Email Subject” box 906 is provided to enter a subject for an email containing a marketing campaign. Also, the subject of the email can be entered in “Email Body” box 908.

In the example displayed, a person affiliated with a marketer Acme Coffee creates a marketing campaign to reach out to consumers via SMS. Contents of the SMS is entered in “SMS Body” box 910. It will be understood that a marketer's promotional message is typically included in the contents of the SMS. For example, in the displayed screenshot 900, the contents of a SMS (as displayed exemplarily in box 910) indicates that a consumer will get a small coffee at any Acme Coffee location on Oct. 6, 2011 if a consumer shows the received SMS at an Acme Coffee location.

In criteria region 911, marketers specify the criteria, parameters, or conditions that must be satisfied by consumer check-ins in order for those consumers to receive targeted content from marketers. For example, a person affiliated with a marketer can choose specific locations corresponding to spatial check-ins by consumers. Such locations can be entered using a “Checkins at Location(s)” box 912. As shown in screenshot 900, exemplary locations comprise Acme Coffee Buckhead, Acme Coffee Virginia Highlands, and several other locations. In one aspect of the present disclosure, the CMS allows marketers to target consumers on the basis of specific geo-locations wherein consumers check-in spatially, or specific times when consumers check-in temporally. (A computer implemented process to identify consumers who match marketing campaign-specific requirements, including specific geo-locations, was described earlier in connection with FIG. 4.) In the displayed screenshot, exemplary check-in locations are illustrated. Further, a “Checkins near Geotarget(s)” box 914 is provided by the CMS to allow marketers to specify specific geo-locations. Also, additional geo-targets can be added to a pre-existing list of geo-targets by a marketer using a “Create New Geo-target” link 915. A list of geo-targets specified by marketers and used by the CMS as campaign-specific matching criteria for purposes of delivery of marketing campaigns to consumers is shown exemplarily in FIG. 10.

According to one aspect of the present disclosure, the CMS allows marketers to specify a vicinity of a geo-location for purposes of offering targeted marketing offers to consumers who are located in the vicinity of the geo-location. Such a vicinity is specified in the form of a “Geo-target Proximity” box 916. Exemplarily, a vicinity can be three (3) miles as shown in screenshot 900, or virtually any other geographical radius, area, delimiter, or the like.

In one aspect, the CMS allows marketers to specify an exact character string corresponding to a name of a place that will match a consumer's spatial geo-location check-in. Such a string can be entered using “Name of Place Must Contain” box 918 on screenshot 900. Thus, if check-in information provided by a LBSN includes a string that matches the marketer's predefined string, then the consumer that initiated the check-in may be eligible to receive the corresponding targeted content. An exemplary marketer called Acme Coffee can create a marketing campaign for an existing location such as an airport, and can further limit the campaign to a specific airport by adding a name such as “Hartsfield Airport.” Thus, if a consumer checks in at any other airport besides “Hartsfield Airport”, then the consumer will not receive the marketing campaign created by Acme Coffee. As will occur to one of ordinary skill in the art, in alternate embodiments of the CMS, marketers can specify various other campaign-specific requirements such as a time of the day, or even a combination of a target time and a geo-location, and possibly many other variations.

Finally a “Save” button 919 allows a marketer to save campaign-related information with the CMS, such information typically being stored in a CMS database. The discussion with reference to a campaign creation interface as shown in FIG. 9 is for exemplary purposes only. It will be understood that no limitation is intended by the present disclosure, any alterations and further modifications of the described interface is possible as would normally occur to one skilled in the art.

Now referring to FIG. 10, an exemplary screenshot 1000 displaying a collection of geo-targets is shown. It will be recalled from the earlier discussions in connection with a marketing campaign creation interface in FIG. 9 that a marketer can specify geo-targets in order to filter consumers (for receiving marketing campaigns) on the basis of specific geo-locations at which consumers check-in. It will be understood that in one aspect of the present disclosure, geo-targets specified by marketers are used as a matching criteria by the CMS for purposes of delivery of marketing campaigns to consumers. (A computer implemented process to identify consumers who match marketing campaign-specific requirements, including checking in at specific geo-targets, was described earlier in connection with FIG. 4.) In other words, those consumers who check-in at the geo-targets specified by marketers, or in a pre-determined vicinity of the geo-targets specified by marketers, will receive targeted marketing campaigns created by the marketer, from the CMS. A collection of such geo-targets pre-specified by a marketer (and stored in the CMS database) is shown in screenshot 1000. For example, one geo-target is specified as Atlanta 33.7489, −84.3879. Various other geo-targets are also specified for an exemplary marketer called Acme Coffee. Although exemplary geo-targets specified in FIG. 10 are represented with a latitude/longitude, it will be understood that geo-targets can be specified according to various other ways, such as street addresses, zip codes, and even temporal events (“locations”), etc.

According to one aspect of the present disclosure, marketers can create marketing campaigns by leveraging their existing consumer bases. In such scenarios, the CMS tracks the activities of individual consumers in the marketer's consumer base when those consumers check-in at various venues.

Now referring to FIG. 11, a screenshot 1100 is shown illustrating information relating to consumer check-ins at various locations, corresponding to a hypothetical marketer called Acme Coffee. According to one aspect, information relating to consumer check-ins at various locations is communicated to the CMS by one or more LBSNs. Such information is received at the CMS, and typically stored in a database. When a person affiliated with the marketer logs into the marketer's account on the CMS, information relating to consumer check-ins is displayed (for example, as shown in FIG. 11) along with various other information.

As shown, a “Time” column 1102 lists a date/time corresponding to each check-in. Also, a name of a geo-location corresponding to a check-in is indicated in the “Name” column 1104. It will be understood that consumers of a marketer are not limited to checking in at a marketer's retail location. For example, as shown in FIG. 11, consumers of Acme Coffee can exemplarily check-in at an AMC Fork and Screen theater. In other words, consumers corresponding to a marketer can check-in at various different locations, and in one aspect, information relating to such check-ins are provided by the CMS to marketers. Further, in FIG. 11, it is shown that a “Latitude/Longitude” column 1106 displays a latitude/longitude corresponding to each check-in. In one aspect, a location sensor embedded in a consumer's mobile device determines a real time location for a consumer, and subsequently a mobile device application program running on the consumer's mobile device communicates such a location to one or more LBSNs, the CMS, and/or various marketers.

Consumers who check-in at various locations are typically identified with unique IDs, as displayed exemplarily in the “Consumer ID” column 1108. It will be generally understood that a consumer can check-in at a location multiple times. Thus, a number of check-ins associated with a consumer is displayed in “Checkins” column 1110. In many scenarios, marketers prefer to initiate some action with respect to the information relating to consumer check-ins. Hence, as shown, an “Actions” column 1112 allows persons affiliated with marketers to edit or delete information relating to consumer check-ins. Alternately, in other scenarios, the CMS can initiate some action with a customer based on a pre-determined rule set by a marketer. Interactions involving the CMS, a marketer, a consumer and multiple LBSNs was described earlier in connection with FIGS. 3A and 3B.

As shown in FIG. 11, a consumer with ID 149100181781512 has checked in (usually with a LBSN) at a geo-location identified as 29.7236, −99.0723 latitude/longitude on May 14, 2011 at 10:40 pm. Although not shown in FIG. 11, it will be understood that in alternate embodiments, the CMS allows marketers to perform several other actions such as add notes, mark check-ins with a different color, sort, display locations on a map or a grid, display check-ins for a particular consumer over a time duration, and various other operations as will occur to one of ordinary skill in the art.

Moreover, it will be understood that embodiments the present system can provide analytics and reports comprising various statistical measures, analyses, and the like relating to consumer behavior and engagements. Such analytics can generally be constructed based on consumer's social check-in activities temporally or spatially. For example, analytics can reveal how many consumers checked-in spatially (or, temporally) with a particular LBSN. In addition, such analytics can identify various actions undertaken by consumers who have been identified by the CMS for receiving targeted marketing offers, and subsequently have received such offers. For example, the frequency of consumer check-ins before and after receiving targeted marketing content from the CMS can be determined. As another example, analytics relating to the success rate or performance of various types of marketing campaigns can be determined based on redemptions associated with targeted marketing offers. Further, various market segmentation measures can be obtained on the basis of age, sex, propensity of group check-ins over individual check-ins, consumers preferences for particular marketers, types of products, venues, events, types of marketing content, and various other analytics as will occur to one of ordinary skill in the art.

As will be generally understood, computing such analytics can involve various statistical tools, statistical models and even regression models to obtain for example, a line of best fit, etc. Other embodiments can use different visualization tools such bar graphs, or other plots, involving data points indicated by different types of markers and/or colors.

As described in detail above, aspects of the present disclosure generally relate to aggregation, manipulation, and management of diverse types of information relating to consumers' social activities, as obtained via a plurality of location based social networks (LBSNs). Information relating to consumers' social activities is collected by one or more LBSNs, and further broadcast to other members of the LBSN, or the consumer's social networks, of which the consumer is a member. In one exemplary aspect, information relating to a consumer's social activities includes a consumer's geo-location in real time, corresponding to a location where the consumer checked-in with one or more LBSNs, wherein the consumer is a member of one or more LBSNs. In one example, if a consumer's geo-location check-in corresponds to one or more physical locations pre-specified by marketers in their marketing campaigns, then a consumer receives targeted marketing content from marketers. In one aspect, consumers check-in using their mobile device such as mobile phones, tablet PC, etc. and thus, receive targeted marketing content from marketers on the respective mobile device. Aspects of the present disclosure are also related to creating and managing targeted marketing content, and further the delivery of such content to consumers based on satisfaction of criteria provided by marketers in their targeted marketing content, with information related to consumer check-ins.

As described herein, such a system has been referred to as a Campaign Management System (CMS). It will be understood that marketers can create targeted marketing campaigns by accessing a CMS user interface (UI) over a computer network, such as the World Wide Web (WWW), using varying types of electronic devices such as smart phones and computers. In one embodiment, consumers check-in at various geo-locations using a mobile device. A mobile device application program running on the mobile device communicates information relating to consumer check-ins to various Location Based Social Networks (LBSNs). Subsequently, the CMS requests information relating to check-in activities of a consumer from multiple LBSNs and further processes the same for extracting analytics relating to consumer behavioral trends. Additionally, in one aspect, the CMS provides targeted marketing campaigns (pre-created by marketers) to consumers. Such marketing campaigns can involve promotional offers, coupons, polls, interactive games, loyalty points, discounts etc. In one aspect, the CMS processes and performs data mining on marketing campaigns in conjunction with information relating to check-in activities of a consumer from multiple LBSNs, in order to identify and match consumers who satisfy various criteria specified in the marketing campaigns, and who will therefore receive targeted marketing content related to the campaigns.

Accordingly, it will be understood from the foregoing description that various embodiments of the present system described herein are generally implemented as a special purpose or general-purpose computer including various computer hardware as discussed in greater detail below. Embodiments within the scope of the present disclosure also include computer-readable media for carrying or having computer-executable instructions or data structures stored thereon. Such computer-readable media can be any available media which can be accessed by a general purpose or special purpose computer, or downloadable through communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, the present disclosure is described in the general context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the present disclosure may be practiced in network computing environments with many types of computer system configurations, including personal computers, hand-held devices, multi-processor systems, microprocessor-based or programmable consumer electronics, networked PCs, minicomputers, mainframe computers, and the like. The present disclosure is practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the present disclosure, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, a script containing computer program code written in a scripting language or other input devices (not shown), such as a microphone, etc. These and other input devices are often connected to the processing unit through known electrical, optical, or wireless connections.

The main computer that effects many aspects of the present disclosure will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which aspects of the present disclosure are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the present disclosure is connected to the local network through a network interface or adapter. When used in a WAN or WLAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the network connections described or shown are exemplary and other means of establishing communications over wide area networks or the Internet may be used.

In view of the foregoing detailed description of preferred embodiments of the present disclosure, it readily will be understood by those persons skilled in the art that the present disclosure is susceptible to broad utility and application. While various aspects have been described in the context of a preferred embodiment, additional aspects, features, and methodologies of the present disclosure will be readily discernable from the description herein, by those of ordinary skill in the art. Many embodiments and adaptations of the present disclosure other than those herein described, as well as many variations, modifications, and equivalent arrangements and methodologies, will be apparent from or reasonably suggested by the present disclosure and the foregoing description thereof, without departing from the substance or scope of the present disclosure. Furthermore, any sequence(s) and/or temporal order of steps of various processes described and claimed herein are those considered to be the best mode contemplated for carrying out the present disclosure. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present disclosure. In addition, some steps may be carried out simultaneously.

Accordingly, while the present disclosure has been described herein in detail in relation to preferred embodiments, it is to be understood that this disclosure is only illustrative and exemplary of the present disclosure and is made merely for purposes of providing a full and enabling disclosure. The foregoing disclosure is not intended nor is to be construed to limit the present disclosure or otherwise to exclude any such other embodiments, adaptations, variations, modifications and equivalent arrangements, the present disclosure being limited only by the claims appended hereto and the equivalents thereof

What is claimed is:

1. A method for delivering targeted content to members of a plurality of location-based social networks (LBSNs), wherein the plurality of LBSNs are in operative communications with a campaign management system (CMS) that enables creation and management of the targeted content, and wherein the targeted content includes one or more campaign criteria that dictates whether targeted content should be delivered to one or more LBSN members, comprising the steps of:
receiving check-in information from the plurality of LBSNs at the CMS indicating social check-in activity for a plurality of LBSN members;
normalizing the check-in information from the plurality of LBSNs at the CMS into a predetermined standardized format, wherein the predetermined standardized format is agnostic of each LBSN format;
retrieving pre-stored targeted content from a CMS database and extracting the one or more campaign criteria from the pre-stored targeted content;
determining whether at least one instance of the normalized check-in information satisfies the one or more campaign criteria in the targeted content; and
if at least one instance of the normalized check-in information satisfies the campaign criteria for the targeted content, delivering the targeted content to at least one LBSN member corresponding to the at least one instance of the normalized check-in information that satisfied the campaign criteria corresponding to the targeted content.

2. The method of claim 1, wherein the check-in information indicates a spatial or temporal social check-in activity for each LBSN member.

3. The method of claim 1, wherein the check-in information comprises one or more of the following: a location identifier indicating a physical location of a LBSN member, a time identifier indicating at time for the social check-in activity, an LBSN member identifier (ID).

4. The method of claim 1, wherein the step of normalizing the check-in information from the plurality of LBSNs at the CMS into the predetermined standardized format comprises the steps of:
querying each of the plurality of LBSNs for a respective check-in information format type for each data category in the check-in information;
associating each respective check-in information format type for each data category for each LBSN with a corresponding, predetermined standardized format type in the predetermined standardized format at the CMS;
extracting each data item from the check-in information, wherein each data item corresponds to a respective data category; and
formatting each data item according to its corresponding, predetermined standardized data format type based on its respective data category.

5. The method of claim 1, wherein the step of normalizing the check-in information from the plurality of LBSNs at the CMS into the predetermined standardized format comprises the steps of:
parsing the check-in information to identify specific data type characteristics corresponding to particular data types;
comparing the identified specific data type characteristics with a predetermined list of specific data type characteristics corresponding to particular data types; and
if the identified specific data type characteristics match one of the predetermined specific data type characteristics, formatting the check-in information to a predetermined standardized format based on an identified data type.

6. The method of claim 1, further comprising the step of, if campaign criteria for more than one instance of targeted content is satisfied, determining respective targeted content to be sent to one or more LBSN members based on a predetermined priority algorithm.

7. The method of claim 1, wherein the step of determining whether at least one instance of the normalized check-in information satisfies the one or more campaign criteria in the targeted content comprises comparing the normalized check-in information to the campaign criteria to identify whether the campaign criteria has been satisfied.

8. The method of claim 1, wherein the at least one LBSN member takes some action with respect to the delivered targeted content to redeem the delivered targeted content.

9. The method of claim 1, further comprising the step of processing information relating to satisfied campaign criteria and delivered targeted content to identify analytics relating to LBSN member behavior.

10. The method of claim 1, wherein the targeted content comprises targeted marketing offers that are dependent upon satisfaction of marketing campaign criteria.

11. The method of claim 1, wherein the targeted content is selected from the group comprising: promotional content, marketing offers, discounts, coupons, polls, loyalty points, online games, reward certificates, free items, requests for action, advertisements.

12. The method of claim 1, wherein the one or more campaign criteria for determining whether the targeted content should be delivered to one or more LBSN members is selected from the group comprising: a spatial location of the social check-in activity, a temporal location of the social check-in activity, a time of the social check-in activity, a history of previous social check-in activities by an LBSN member, demographic information, previously-indicated preferences for LBSN members, group check-ins.

13. The method of claim 1, further comprising the step of communicating information from the CMS to one or more marketers that created the targeted content corresponding to satisfaction of campaign criteria associated with targeted content.

14. The method of claim 1, wherein the check-in information is communicated from an LBSN member to an LBSN via a mobile device application program running on the LBSN member's mobile device.

15. The method of claim 1, wherein the step of delivering the targeted content to at least one LBSN member comprises displaying the targeted content on a mobile device of the LBSN member.

16. The method of claim 1, wherein the step of delivering the targeted content to at least one LBSN member comprises delivering the content via one or more of the following: short messaging service (SMS) message, multimedia messaging service (MMS) message, email, voicemail, social media system message, LBSN message, telephone communication, providing a link to a website, sending hard copy content.

17. A method for delivering targeted marketing offers to members of a plurality of location-based social networks (LBSNs), wherein the plurality of LBSNs are in operative communications with a campaign management system (CMS) that enables creation and management of the targeted marketing offers, comprising the steps of:
receiving marketing campaign information at the CMS from one or more marketers corresponding to targeted marketing offers to be delivered to one or more LBSN members, wherein the marketing campaign information includes one or more campaign criteria that dictates whether corresponding targeted marketing offers should be delivered to the one or more LBSN members;
querying the plurality of LBSNs for check-in information indicating social check-in activity for a plurality of LBSN members;
receiving check-in information from the plurality of LBSNs at the CMS;
normalizing the check-in information from the plurality of LBSNs at the CMS into a predetermined standardized format, wherein the predetermined standardized format is agnostic of each LBSN format;
identifying one or more LBSN members to whom one or more targeted marketing offers should be delivered based on a comparison of the normalized check-in information for each LBSM member against the one or more campaign criteria associated with the targeted marketing offers; and
delivering the one or more targeted marketing offers to the one or more LBSN members whose normalized check-in information satisfied the one or more campaign criteria.

18. The method of claim 17, wherein the check-in information indicates a spatial or temporal social check-in activity for each LBSN member.

19. The method of claim 17, wherein the check-in information comprises one or more of the following: a location identifier indicating a physical location of a LBSN member, a time identifier indicating at time for the social check-in activity, an LBSN member identifier (ID).

20. The method of claim 17, wherein the step of normalizing the check-in information from the plurality of LBSNs at the CMS into the predetermined standardized format comprises the steps of:
querying each of the plurality of LBSNs for a respective check-in information format type for each data category in the check-in information;
associating each respective check-in information format type for each data category for each LBSN with a corresponding, predetermined standardized format type in the predetermined standardized format at the CMS;
extracting each data item from the check-in information, wherein each data item corresponds to a respective data category; and
formatting each data item according to its corresponding, predetermined standardized data format type based on its respective data category.

21. The method of claim 17, wherein the step of normalizing the check-in information from the plurality of LBSNs at the CMS into the predetermined standardized format comprises the steps of:
parsing the check-in information to identify specific data type characteristics corresponding to particular data types;
comparing the identified specific data type characteristics with a predetermined list of specific data type characteristics corresponding to particular data types; and
if the identified specific data type characteristics match one of the predetermined specific data type characteristics, formatting the check-in information to a predetermined standardized format based on an identified data type.

22. The method of claim 17, wherein the step of delivering the one or more targeted marketing offers to the one or more LBSN members comprises displaying the one or more targeted marketing offers on a mobile device of each LBSN member.
